(19) United States
(12) Patent Application Publication
(10) Pub. No.: US 2026/0074955 A1
(43) Pub. Date: Mar. 12, 2026

(54) SYSTEMS AND METHODS FOR PROVIDING ADAPTIVE USER EQUIPMENT MANAGEMENT IN A PRIVATE NETWORK

(71) Applicant: Verizon Patent and Licensing Inc., Basking Ridge, NJ (US)

(72) Inventors: Vaibhav ARORA, Sharon, MA (US); Nandan NAIK, Salem, MA (US); Mostafa TOFIGHBAKHSH, Cupertino, CA (US); LaQuiesia WILKINS, Powder Springs, GA (US); Sanjeevan SIVALINGHAM, Vacaville, CA (US); Sunil YADAWAD, Westford, MA (US)

(73) Assignee: Verizon Patent and Licensing Inc., Basking Ridge, NJ (US)

(21) Appl. No.: 18/883,092

(22) Filed: Sep. 12, 2024

(51) Int. Cl. H04L 41/0894; H04L 12/46; H04L 41/0806

(52) U.S. Cl. CPC H04L 41/0894; H04L 12/4641; H04L 41/0806

(57) ABSTRACT

A device may receive a natural language user equipment (UE) policy for a UE associated with a private network, and may compile the natural language UE policy into a UE configuration script. The device may execute the UE configuration script to provision the UE relative to the private network, and may receive monitoring data identifying activities of the UE within the private network after execution of the UE configuration script. The device may process the monitoring data, with a machine learning model, to generate a new UE policy for the UE, and may update the UE configuration script based on the new UE policy and to generate an updated UE configuration script. The device may execute the updated UE configuration script to reprovision the UE relative to the private network.

### BACKGROUND

In the rapidly advancing landscape of telecommunications, there has been an increased focus on private networks that cater to needs of enterprises and user equipments (UEs) associated with the enterprises.

### BRIEF DESCRIPTION OF THE DRAWINGS

FIGS. 1A-1F are diagrams of an example associated with providing adaptive UE management in a private network.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for providing adaptive UE management in a private network.

### DETAILED DESCRIPTION OF EXAMPLE EMBODIMENTS

The following detailed description of example implementations refers to the accompanying drawings. The same reference numbers in different drawings may identify the same or similar elements.

A significant challenge that enterprises face with respect to utilization of private networks is a lack of control and flexibility over UEs (e.g., subscriber identity modules (SIMs) of UEs) due to intricate and rigid processes involved in SIM provisioning. Enterprises require capabilities to enforce business policies effectively and adaptively manage UEs within private network infrastructures of the enterprises. The business policies may include geofencing, grouping, security enforcement, and/or the like. However, the lack of control over provisioning of UEs prevents the enterprises from effectively enforcing the business policies and adaptively managing the UEs. Thus, current techniques for handling provisioning of UEs for a private network consume computing resources (e.g., processing resources, memory resources, communication resources, and/or the like), networking resources, and/or other resources associated with failing to properly provision UEs attached to private networks, handling congestion in private networks due to failing to properly provision the UEs, failing to rapidly scale up or down a private network infrastructure in response to fluctuations in demand by UEs while maintaining alignment with business policies, and/or the like.

Some implementations described herein relate to a management system that provides adaptive UE management in a private network. For example, the management system may receive a natural language UE policy for a UE associated with a private network, and may compile the natural language UE policy into a UE configuration script. The management system may execute the UE configuration script to provision the UE relative to the private network, and may receive monitoring data identifying activities of the UE within the private network after execution of the UE configuration script. The management system may process the monitoring data, with a machine learning model, to generate a new UE policy for the UE, and may update the UE configuration script based on the new UE policy and to generate an updated UE configuration script. The management system may execute the updated UE configuration script to reprovision the UE relative to the private network.

In this way, the management system provides adaptive UE management in a private network. For example, the management system may manage UEs and SIMs within private networks that support technologies, such as fourth-generation (4G) long-term evolution (LTE) networks and fifth-generation (5G) networks. The management system may provide automated policy management of UEs and machine learning-based adjustments to UE configurations. This may provide enterprises with enhanced control over private network infrastructures, and reduce a demand for manual configuration changes and administrative oversight. The management system may dynamically adapt policies in real time, and may utilize data-driven insights and predictive modeling to enhance private network reliability and reduce periods of network unavailability due to misconfiguration. Thus, the management system may conserve computing resources, networking resources, and/or other resources that would have otherwise been consumed by failing to properly provision UEs attached to private networks, handling congestion in private networks due to failing to properly provision the UEs, failing to rapidly scale up or down a private network infrastructure in response to fluctuations in demand by UEs while maintaining alignment with business policies, and/or the like.

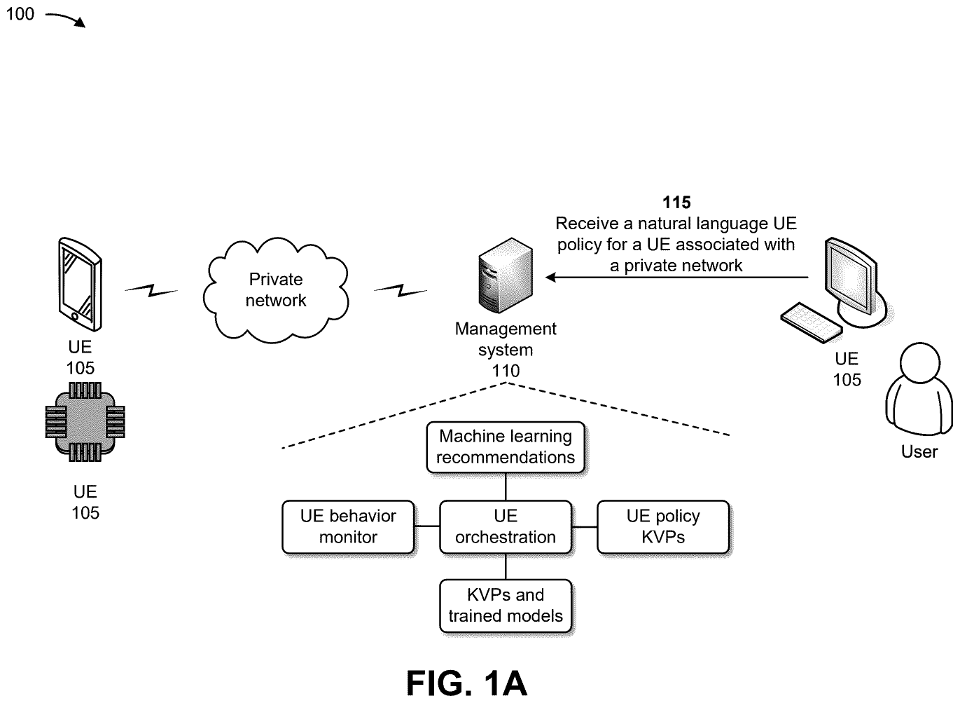

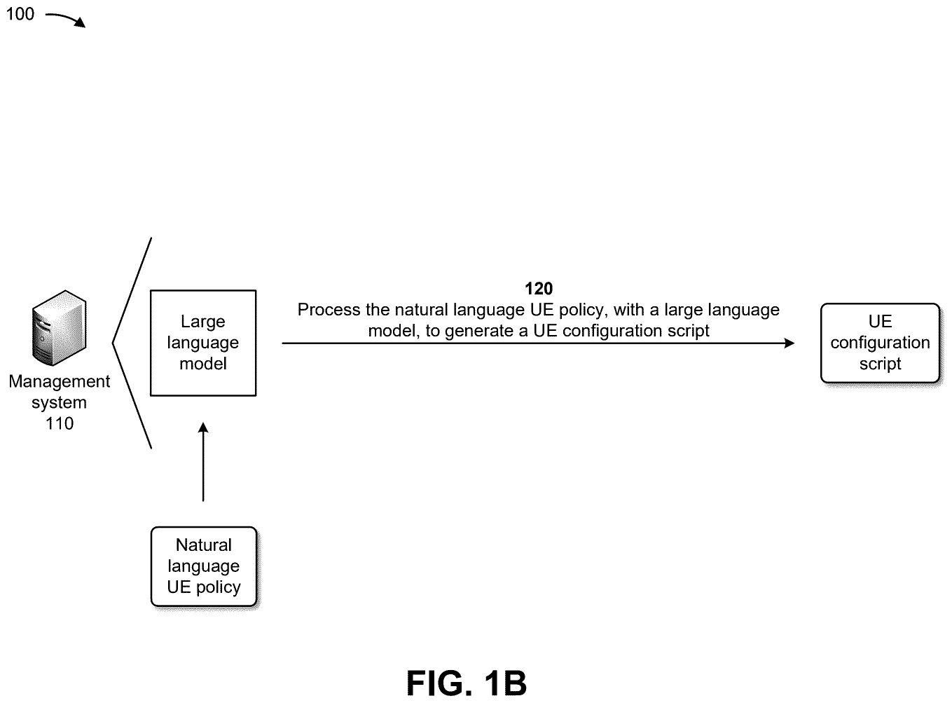

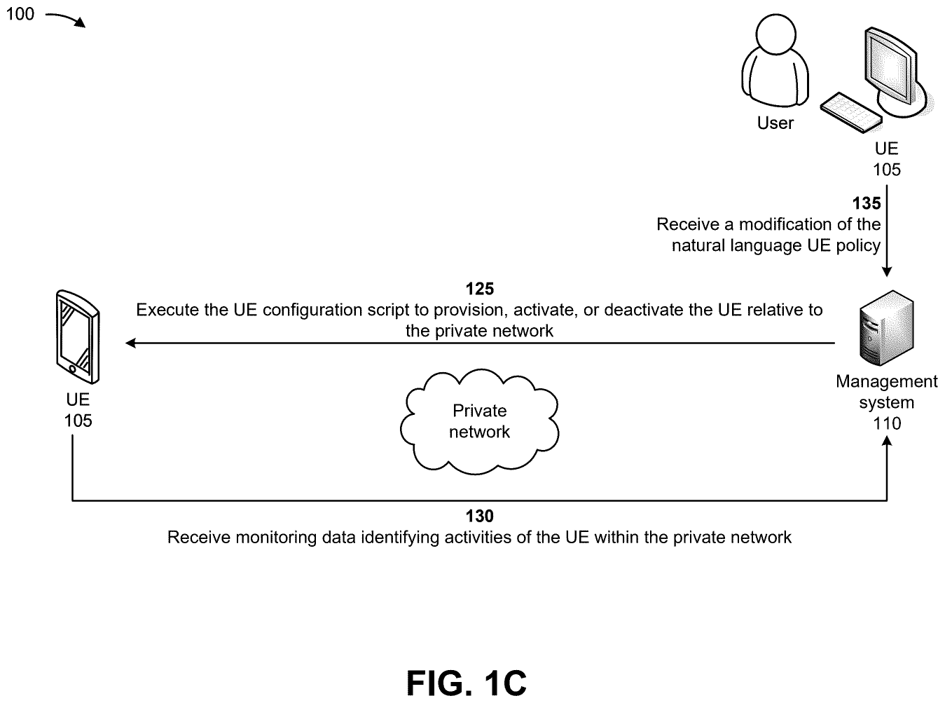

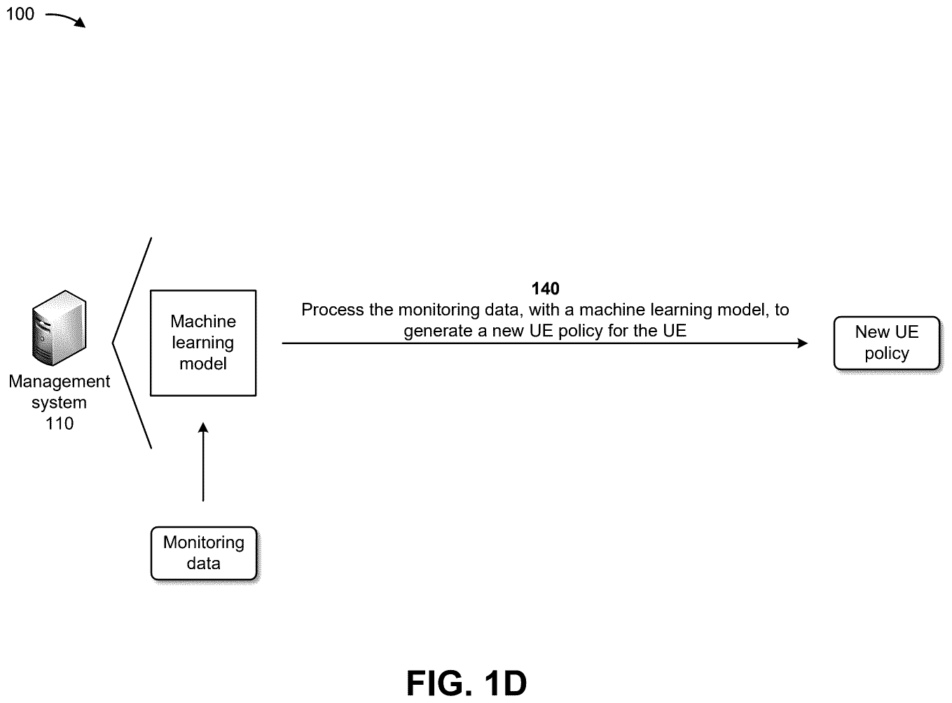

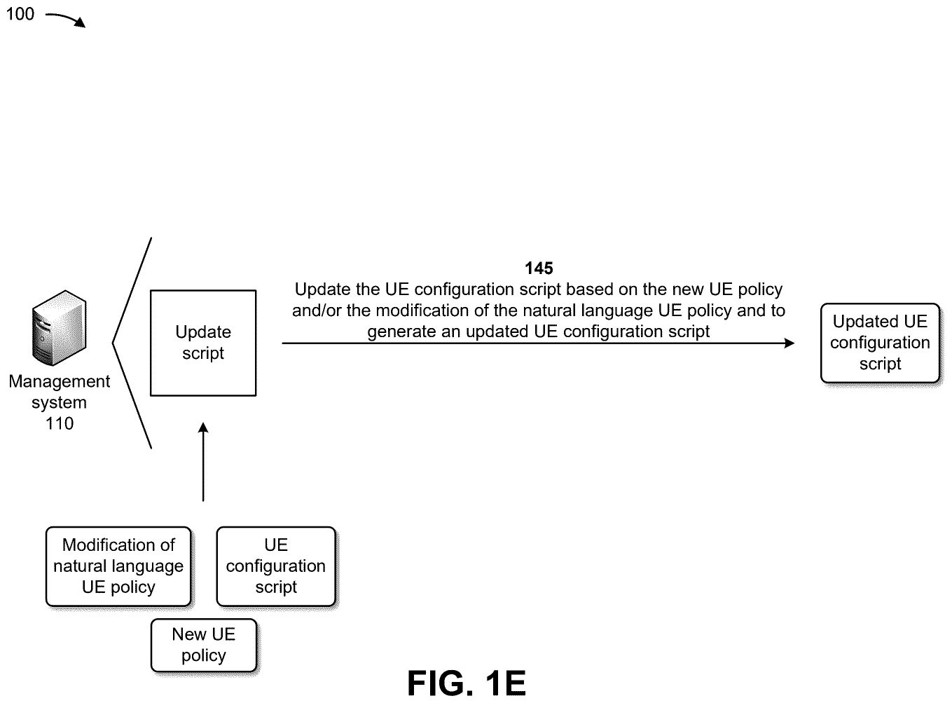

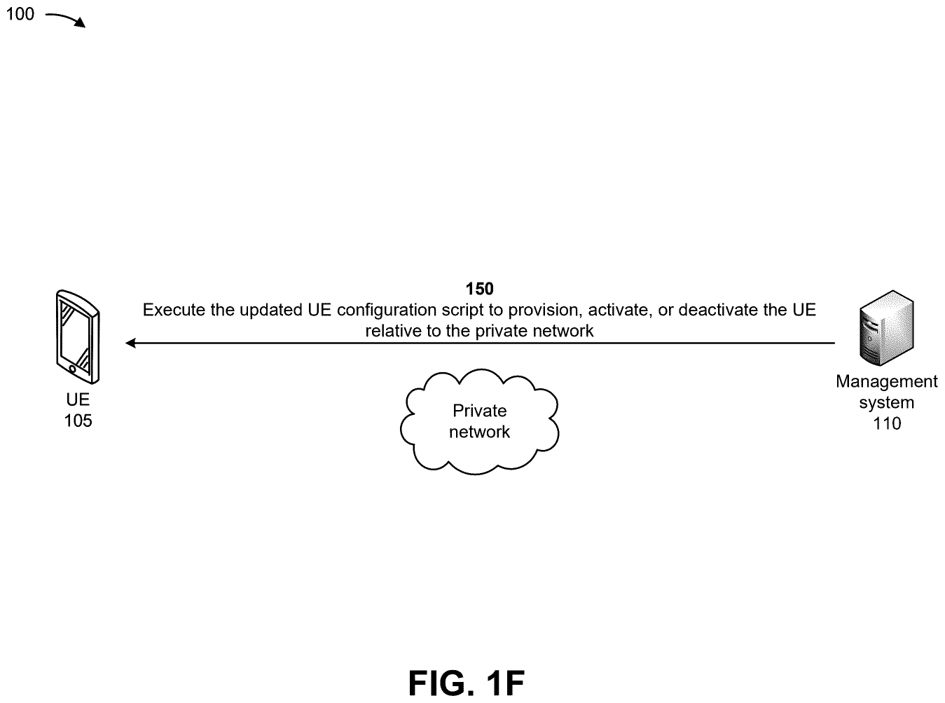

FIGS. 1A-1F are diagrams of an example 100 associated with providing adaptive UE management in a private network. As shown in FIGS. 1A-1F, example 100 includes user equipments (UEs) 105 associated with a private network and a management system 110. Further details of the UEs 105, the private network, and the management system 110 are provided elsewhere herein.

As shown in FIG. 1A, the management system 110 may include a UE orchestration component that receives machine learning recommendations, monitored UE behavior, UE policy key value pairs (KVPs), and KVPs and trained models. The UE orchestration component may process the received information to generate updated UE configuration scripts for the UEs 105, and may execute the updated UE configuration scripts to provision, activate, or deactivate the UEs 105, as described below. As further shown in FIG. 1A, and by reference number 115, the management system 110 may receive a natural language UE policy for the UE 105 associated with the private network. For example, a user (e.g., a private network administrator) may input the natural language UE policy to a user device (e.g., a UE 105), and the UE 105 may provide the natural language UE policy to the management system 110. In some implementations, the natural language UE policy may include a rule for geo-fencing for the UE 105 associated with the private network, a rule for UE grouping for the UE 105, a rule for security enforcement for the UE 105, and/or the like.

In some implementations, the management system 110 may provide, to a private network administrator, a graphical user interface for describing UE policies and intents, and may receive the natural language UE policy via the graphical user interface. For example, the private network administrator may pre-configure UE policies according to business needs, and may describe intentions and policies in natural language. The private network administrator may utilize the user interface to describe, in natural language, UE rules and policies for each device category or specific user. In one example, the private network administrator may wish to customize UE management per specific device type, user type or location, device behaviors (e.g., three-dimensional location, device speed, device mobile direction, usage patterns, and/or the like), and/or the like (e.g., to implement a policy where all tablet devices are provided higher priority over other device types). In another example, the private network administrator may wish to dynamically change policy rules per UE 105 and enforce certain behaviors for each UE 105 by enabling automation for continued adaptation to business needs (e.g., to implement a policy where Group A UEs 105 can only be active from 8:00 AM to 5:00 PM, Group B UEs 105 may be limited to specific cell site locations, and Group C UEs 105 may be associated with a higher service level agreement (SLA)). In still another example, the private network administrator may wish to permit machine learning models to optimize UE policies and enforce new intents to enhance user experiences for the UEs 105 (e.g., to implement a policy where UEs 105 that are outliers are automatically moved to a specific network slice).

As shown in FIG. 1B, and by reference number 120, the management system 110 may process the natural language UE policy, with a large language model (LLM), to generate a UE configuration script. For example, the management system 110 may utilize the LLM to generate, based on the natural language UE policy, a UE configuration script that is specific to the UE 105 associated with the private network. In some implementations, the LLM may be a transformer-based model, a recurrent neural network (RNN) model, or another type of model that is capable of processing natural language input. As described elsewhere herein, the UE configuration script, when executed by the management system 110, may provision the UE 105 associated with the private network.

In some implementations, the management system 110 may process the natural language UE policy using other techniques, such as rule-based systems, decision trees or random forests, clustering models, or reinforcement learning to generate the UE configuration script. For example, the management system 110 may utilize a rule-based system to generate a UE configuration script based on predefined rules. Alternatively, the management system 110 may utilize a decision tree model or a random forest model to generate a UE configuration script based on a set of input parameters. Additionally, the management system 110 may utilize clustering models to group similar UEs 105 and generate a UE configuration script for each group of UEs 105. In some implementations, the management system 110 may use ensemble methods to combine predictions of multiple models and generate the UE configuration script. For example, the management system 110 may use a combination of an LLM and a decision tree model to generate the UE configuration script.

In some implementations, the management system 110 may utilize the LLM or a small language model to make group or individual UE level decisions with respect to the UE configuration script. For example, the natural language UE policy may indicate that all video devices are to be provided a new SIM management profile. As the result, the LLM may convert the natural language policy to a SIM management profile script that be executed to provide the new SIM management profile to the video devices.

The management system 110 may enable the private network administrator to self-manage policies and intents for the UEs 105, and may perform various automated UE management functions. The management system 110 may provide an intent framework that utilizes KVPs that map UEs 105 by device name or group categories, or utilizes behavior models with pointers to the UEs 105, where the private network administrator need not remember or input actual identifiers (e.g., SIM identifiers) of the UEs 105. Instead, the private network administrator may describe intentions in natural language, and the management system 110 may compile the intentions into a set of UE provisioning management scripts and network actions.

The management system 110 may map UE policies into a set of actionable network functions and may autonomously identify UE behaviors that are outliers. The management system 110 may force UEs 105 that are outliers to adopt new UE policies via automation. The management system 110 may then apply the UE management changes using automation based on insights from machine learning models.

As shown in FIG. 1C, and by reference number 125, the management system 110 may execute the UE configuration script to provision, activate, or deactivate the UE 105 relative to the private network. For example, the management system 110 may utilize the generated UE configuration script to adjust network settings and policies associated with the UE 105 to align with requirements of the private network, enabling or disabling specific functionalities as needed. In some implementations, executing the UE configuration script may include the management system 110 deploying the UE configuration script to configure network-access parameters for the UE 105 concerning the private network. The management system 110 may, for example, configure Internet protocol (IP) addresses, domain name system (DNS) settings, and virtual private network (VPN) configurations tailored for the UE 105 to ensure seamless network access. Additionally, or alternatively, executing the UE configuration script may include the management system 110 executing the UE configuration script to dynamically manage access controls for the UE 105 within the private network according to enterprise policies. This could involve, for example, setting user-specific access permissions, time-based access constraints, or role-based access controls that dynamically adjust based on a user profile of the UE 105. Additionally, or alternatively, executing the UE configuration script may include the management system 110 executing the UE configuration script to apply security protocols and policies on the UE 105 in connection to the private network. This may include deploying encryption policies, authentication mechanisms, or other security measures to safeguard data transmitted to and from the UE 105.

As further shown in FIG. 1C, and by reference number 130, the management system 110 may receive monitoring data identifying activities of the UE 105 within the private network. For example, after executing the UE configuration script, the management system 110 may monitor activities of the UE 105 within the private network, and may receive the monitoring data based on monitoring the activities of the UE 105. The management system 110 may utilize network monitoring tools to receive the monitoring data or may receive the monitoring data directly from the UE 105. The monitoring data may include usage patterns, data consumption, geographic locations, and/or the like associated with the UE 105. In some implementations, receiving the monitoring data may include the management system 110 collecting activity logs indicating interactive sessions, bandwidth consumption, and mobility patterns of the UE 105 within the private network. The activity logs may provide detailed insights into behavior of the UE 105 and network resource utilization by the UE 105. Additionally, or alternatively, receiving the monitoring data may include the management system 110 obtaining telemetry data that details application usage, signal strength, and roaming status of the UE 105. Such telemetry data can help in identifying connectivity issues and optimizing network performance. Additionally, or alternatively, receiving the monitoring data may include the management system 110 acquiring event records and utilization statistics from the private network infrastructure and the UE 105 to monitor performance and compliance with set policies. This can involve the management system 110 tracking system alerts, error rates, and overall network health metrics.

As further shown in FIG. 1C, and by reference number 135, the management system 110 may receive a modification of the natural language UE policy. For example, the private network administrator may update the UE policy through the graphical user interface provided by the management system 110, describing desired changes to the UE policy in natural language. The management system 110 may utilize this updated UE policy to adjust the UE configuration script correspondingly, ensuring that the requirements of the private network and business policies are satisfied. In some implementations, receiving the modification of the natural language UE policy may include the management system 110 registering changes to the natural language UE policy submitted via an administrative console integrated into the management system 110. For example, the private network administrator may log into the console to input and submit revised policy specifications.

Additionally, or alternatively, receiving the modification of the natural language UE policy may include the management system 110 ingesting new policy directives inputted through an interactive dashboard, and translating the new policy directives into updates for the UE configuration script. This could involve the management system 110 providing a dashboard that provides various user interface elements, such as sliders, drop-down menus, or text boxes to formulate and submit UE policy changes in an intuitive manner. Additionally, or alternatively, receiving the modification of the natural language UE policy may include the management system 110 processing revision commands entered in natural language via a policy management portal, and automatically refining the UE configuration script to incorporate the revision commands. For example, the private network administrator may provide the UE policy updates in plain language commands, and the management system 110 may employ natural language processing to convert the plain language commands into actionable UE configuration script updates.

As shown in FIG. 1D, and by reference number 140, the management system 110 may process the monitoring data, with a machine learning model, to generate a new UE policy for the UE 105. For example, the management system 110 may utilize the machine learning model to analyze patterns and insights from the received monitoring data, which may include information associated with usage patterns, data consumption, geographic locations, and/or the like related to the UE 105. The machine learning model may identify deviations or trends in the UE behavior and accordingly may generate a new UE policy that aligns with enterprise guidelines and operational policies. The new UE policy generated by the machine learning model may ensure that the UE 105 operates within an updated framework defined by the enterprise, accommodating dynamic changes and optimizations based on real-time data analytics.

In some implementations, the management system 110 may utilize a neural network model to interpret the monitoring data and generate the new UE policy for the UE 105. The neural network model may deeply analyze complex patterns within the monitoring data, leading to a more tailored and effective UE policy. Additionally, or alternatively, the management system 110 may utilize artificial intelligence (AI)-assisted analytics to create the new UE policy for the UE 105. These analytics may employ a range of models and AI techniques to derive insights and recommendations from the monitoring data, enhancing the responsiveness and accuracy of UE policy updates. Additionally, or alternatively, the management system 110 may utilize multiple machine learning models to formulate a new UE policy for the UE 105. The models may include a supervised learning model, an unsupervised learning model, a reinforcement learning model, and/or the like that continuously improve the UE policy based on ongoing UE behavior data.

Additionally, or alternatively, the management system 110 may utilize deep learning models to generate the new UE policy for the UE 105. Deep learning, characterized by deep neural networks, allows for sophisticated recognition of complex patterns and anomalies in the monitoring data, facilitating more precise policy adjustments. Additionally, or alternatively, the management system 110 may utilize predictive analytics to develop the new UE policy for the UE 105. Predictive analytics can anticipate future trends and needs, ensuring that the UE policy stays ahead of potential issues and performance requirements. Additionally, or alternatively, the management system 110 may utilize data-driven methodologies to generate the new UE policy for the UE 105. Such methodologies can systematically analyze massive datasets to identify actionable insights and opportunities for policy improvement.

Additionally, or alternatively, the management system 110 may utilize adaptive learning models to evolve and generate the new UE policy for the UE 105. Adaptive learning models continuously adjust based on incoming data, ensuring that the UE policy remains relevant and effective over time. Additionally, or alternatively, the management system 110 may utilize pattern recognition from machine learning to formulate the new UE policy for the UE 105. Pattern recognition techniques can detect and characterize recurring behaviors within the monitoring data, leading to more informed policy decisions. Additionally, or alternatively, the management system 110 may utilize statistical models to conceptualize the new UE policy for the UE 105. Statistical models provide robust mathematical frameworks for analyzing the data, ensuring that derived UE policies are both scientifically sound and practically applicable.

As shown in FIG. 1E, and by reference number 145, the management system 110 may update the UE configuration script based on the new UE policy and/or the modification of the natural language UE policy and to generate an updated UE configuration script. For example, the management system 110 may utilize the new UE policy and modifications to the natural language UE policy to adjust and refine the UE configuration script accordingly. This may ensure that the UE 105 continues to operate within updated parameters and requirements defined by enterprise policies, thus maintaining optimal control and flexibility over the UEs 105 within the private network. The updated UE configuration script may include revised network-access parameters, updated security protocols, altered access controls, and/or the like tailored to the new UE policy and/or the modification of the natural language UE policy.

In some implementations, the management system 110 may process historical monitoring data and the new UE policy to create an enhanced UE configuration script that adjusts connectivity and operational parameters dynamically. For example, the historical monitoring data could provide insights on past usage patterns, enabling the UE configuration script to prioritize network bandwidth for critical applications during peak times. Additionally, or alternatively, the management system 110 may employ machine learning models to analyze the new UE policy, as well as any modifications to the natural language UE policy, resulting in an adaptive UE configuration script tailored to current network demands. For instance, the machine learning models may predict potential vulnerabilities and implement security measures proactively. Additionally, or alternatively, the management system 110 may generate the updated UE configuration script by integrating feedback from real-time network activities and user behavior data, ensuring that the UE 105 is provisioned according to latest enterprise policies. This may involve adapting access controls based on real-time user activity trends to enhance security.

Additionally, or alternatively, the management system 110 may utilize artificial intelligence to update the UE configuration script, incorporating changes from the new UE policy and any manual adjustments to the natural language UE policy. For example, artificial intelligence can identify inefficiencies in the current UE configuration script and recommend optimizations. Additionally, or alternatively, the management system 110 may update the UE configuration script by collating and processing new policy requirements and user behavior patterns, subsequently provisioning the UE 105 to align with the revised network protocols and performance metrics. This may involve adjusting frequency of data synchronization based on user activity patterns to ensure efficient use of network resources.

Additionally, or alternatively, the management system 110 can utilize predictive analytics on the modifications and existing UE performance data to update and refine the UE configuration script for improved operational efficiency. For example, predictive models can forecast future network loads and adjust the UE configuration script to mitigate potential bottlenecks. Additionally, or alternatively, the management system 110 may automate the generation of the updated UE configuration script by merging new policy directives with historical and ongoing monitoring data, facilitating seamless provisioning and management of the UE 105. This may ensure that adjustments are continuously made to optimize performance and security.

Additionally, or alternatively, the management system 110 may analyze and integrate machine learning model predictions based on the new UE policy and the natural language UE policy modification to produce the updated UE configuration script that enhances compliance and security features. For example, compliance requirements can be satisfied automatically by monitoring and adjusting to regulatory changes. Additionally, or alternatively, the management system 110 may formulate the updated UE configuration script by systematically applying new policy conditions and corresponding model adjustments to ensure consistent and secure connectivity within the private network. Additionally, or alternatively, the management system 110 may automatically derive updates to the UE configuration script based on a blend of new UE policies, user feedback, and machine learning insights, which may optimize device behavior and network utilization in real-time. For example, real-time feedback and analytics can continuously refine the UE configuration script to adapt to changing user habits and network performance parameters.

As shown in FIG. 1F, and by reference number 150, the management system 110 may execute the updated UE configuration script to provision, activate, or deactivate the UE 105 relative to the private network. For example, the management system 110 may utilize the updated UE configuration script to modify access controls, update network configurations, or adjust security profiles of the UE 105 in accordance with latest enterprise policies. This may ensure that the UE 105 functions according to the dynamic requirements of the private network, enabling seamless adaptation to changes in policy and operational needs. Additionally, or alternatively, the management system 110 may execute the updated UE configuration script to change service priorities for the UE 105, effectively managing network resources and enhancing overall efficiency.

In some implementations, the management system 110 may execute the updated UE configuration script to adjust a bandwidth allocation for the UE 105 within the private network. For example, the management system 110 can dynamically allocate more bandwidth to the UE 105 during peak usage times or reduce bandwidth during low usage periods to optimize overall network performance. Additionally, or alternatively, the management system 110 may execute the updated UE configuration script to alter the connectivity options available to the UE 105, such as prioritizing 5G connectivity over Wi-Fi. For example, the updated UE configuration script can be configured to switch the UE 105 to 5G connectivity when high-speed data transfer is required for specific applications. Additionally, or alternatively, the management system 110 may execute the updated UE configuration script to dynamically change quality-of-service (QoS) parameters for the UE 105, ensuring optimal performance based on current network conditions and usage patterns. For example, the management system 110 can adjust QoS settings to prioritize latency-sensitive applications like video calls over other types of data traffic.

Additionally, or alternatively, the management system 110 may execute the updated UE configuration script to enforce geo-fencing rules, restricting or enabling access of the UE 105 based on geographic location. For example, the management system 110 may restrict the UE 105 from accessing certain network resources when it is detected outside of corporate premises. Additionally, or alternatively, the management system 110 may execute the updated UE configuration script to configure specific application usage policies, such as granting or restricting access to certain enterprise applications on the UE 105. This can be particularly useful in limiting access to high-risk applications in scenarios requiring heightened security.

Additionally, or alternatively, the management system 110 may execute the updated UE configuration script to adjust roaming permissions for the UE 105 within the private network, controlling an ability of the UE 105 to access external networks or segments of the private network. For example, the UE 105 can be restricted from roaming onto non-enterprise networks to ensure compliance with data privacy regulations. Additionally, or alternatively, the management system 110 may execute the updated UE configuration script to automatically update security settings of the UE 105, such as enabling or disabling VPN access, based on newly identified threats or compliance requirements. This can help in quickly adapting to evolving security threats, ensuring that the UE 105 maintains a secure connection at all times.

Additionally, or alternatively, the management system 110 may execute the updated UE configuration script to implement new device grouping policies, classifying the UE 105 into different groups for optimized resource management. Additionally, or alternatively, the management system 110 may execute the updated UE configuration script to periodically execute health checks and diagnostics on the UE 105, ensuring that the UE 105 remains compliant with enterprise standards. This can involve running software updates or conducting system performance tests to maintain optimal functionality. Additionally, or alternatively, the management system 110 may execute the updated UE configuration script to manage power settings on the UE 105, optimizing battery usage according to enterprise policies and operational needs. For example, the updated UE configuration script could cause the UE 105 to lower the screen brightness or disable non-essential background services when the UE 105 is detected to be running low on battery.

In some implementations, during provisioning of the UEs 105, SIM cards of the UEs 105 may be pre-configured with data, such as International Mobile Subscriber Identities (IMSIs), authentication keys, and network specific settings. The management system 110 may encrypt SIM card credentials in a private network data structure (e.g., a database, a table, a list, and/or the like) and may securely configure the SIM card credentials on the private network. Each SIM card may be identified using a unique Integrated Circuit Card Identification (ICCID) number, and may be utilized to associate the SIM card with users or UEs 105. In some implementations, the management system 110 may collect and analyze data identifying SIM usage in order to offer personalized services. The management system 110 may utilize analytics to predict and prevent potential issues with the UEs 105. SIM provisioning based on UE behaviors may include the management system 110 dynamically adapting the provisioning process to the patterns and preferences of end users. The management system 110 may utilize data analytics and machine learning models to tailor the provisioning process for improved user experience and network efficiency.

In some implementations, the management system 110 may utilize a variety of data sources. For example, the management system 110 may collect data on how users utilize the UEs 105, including data consumption, call patterns, and application usage. The management system 110 may track the geographic locations where the UEs 105 are primarily utilized, and may identify device types and capabilities of the UEs 105. The management system 110 may gather private network data from network monitoring systems, and may utilize sensors in the UEs 105 for additional context. The management system 110 may also collect data directly from users of the UEs 105 through surveys or settings in applications.

In some implementations, the management system 110 may utilize machine learning models and analytics. For example, the management system 110 may utilize pattern recognition models, clustering models to group UEs 105 with similar behaviors, predictive analytics to predict future usage patterns based on historical data, behavioral models, and/or the like. In some implementations, the management system 110 may create detailed user profiles for different user types of the UEs 105, and may compile real time intention to enforcement UE policies. The management system 110 may develop context-aware models that consider context, such as time of day, location, and device state.

In some implementations, the management system 110 may provide a secure environment for the private network and the UEs 105. For example, SIM authentication keys are not required to be inputted entered by enterprise or private network administrators. A SIM card of a UE 105, when activated, may automatically receive access to the private network using a synchronized identity management process. Communication of the UEs 105 with the private network may be secure and not open to security vulnerabilities as key configurations are only known to the SIM cards and the private network.

In this way, the management system 110 provides adaptive UE management in a private network. For example, the management system 110 may manage UEs 105 and SIMs within private networks that support technologies, such as 4G LTE networks and 5G networks.

The management system 110 may provide automated policy management of UEs 105 and machine learning-based adjustments to UE configurations. This may provide enterprises with enhanced control over private network infrastructures, and reduce a demand for manual configuration changes and administrative oversight. The management system 110 may dynamically adapt policies in real time, and may utilize data-driven insights and predictive modeling to enhance private network reliability and reduce periods of network unavailability due to misconfiguration. Thus, the management system 110 may conserve computing resources, networking resources, and/or other resources that would have otherwise been consumed by failing to properly provision UEs 105 attached to private networks, handling congestion in private networks due to failing to properly provision the UEs 105, failing to rapidly scale up or down a private network infrastructure in response to fluctuations in demand by UEs 105 while maintaining alignment with business policies, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

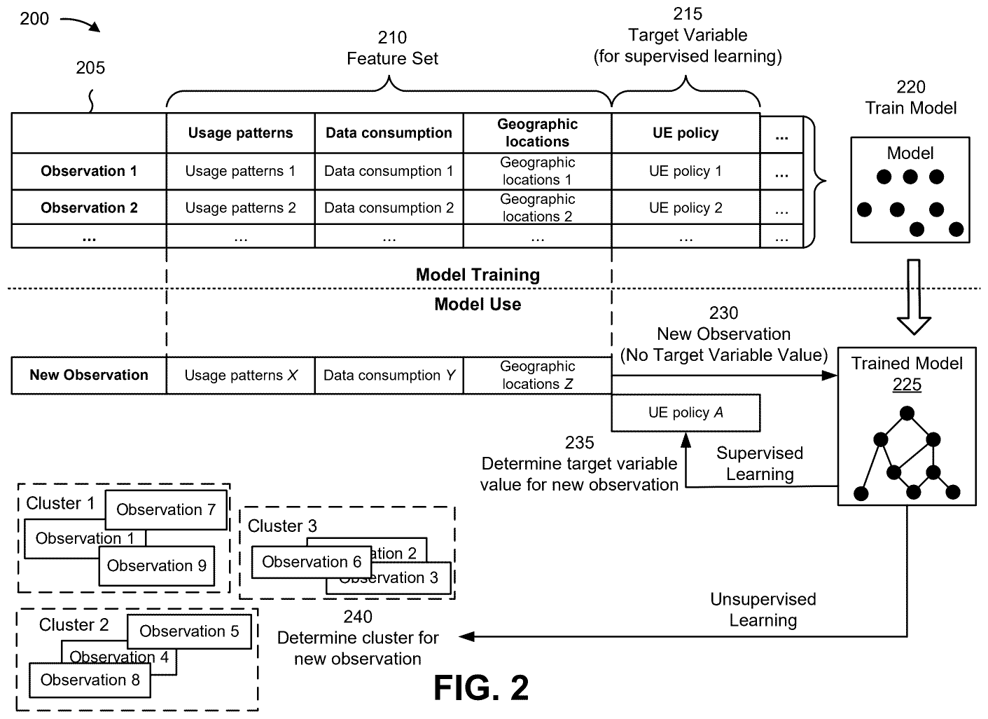

FIG. 2 is a diagram illustrating an example 200 of training and using a machine learning model for generating a UE policy based on monitoring data identifying activities of the UE 105 within the private network. The machine learning model training and usage described herein may be performed using a machine learning system. The machine learning system may include or may be included in a computing device, a server, a cloud computing environment, and/or the like, such as the management system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the management system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the management system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of usage patterns, a second feature of data consumption, a third feature of geographic locations, and so on. As shown, for a first observation, the first feature may have a value of usage patterns 1, the second feature may have a value of data consumption 1, the third feature may have a value of geographic locations 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “UE policy” and may include a value of UE policy 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of usage patterns X, a second feature of data consumption Y, a third feature of geographic locations Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of UE policy A for the target variable of the actions for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a usage patterns cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a data consumption cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate a UE policy based on monitoring data identifying activities of the UE 105 within the private network. The machine learning system enables recognition and/or identification of tens, hundreds, thousands, or millions of features and/or feature values for tens, hundreds, thousands, or millions of observations, thereby increasing accuracy and consistency and reducing delay associated with generating a UE policy based on monitoring data identifying activities of the UE 105 within the private network relative to requiring computing resources to be allocated for tens, hundreds, or thousands of operators to manually generate a UE policy based on monitoring data identifying activities of the UE 105 within the private network.

As indicated above, FIG. 2 is provided as an example. Other examples may differ from what is described in connection with FIG. 2.

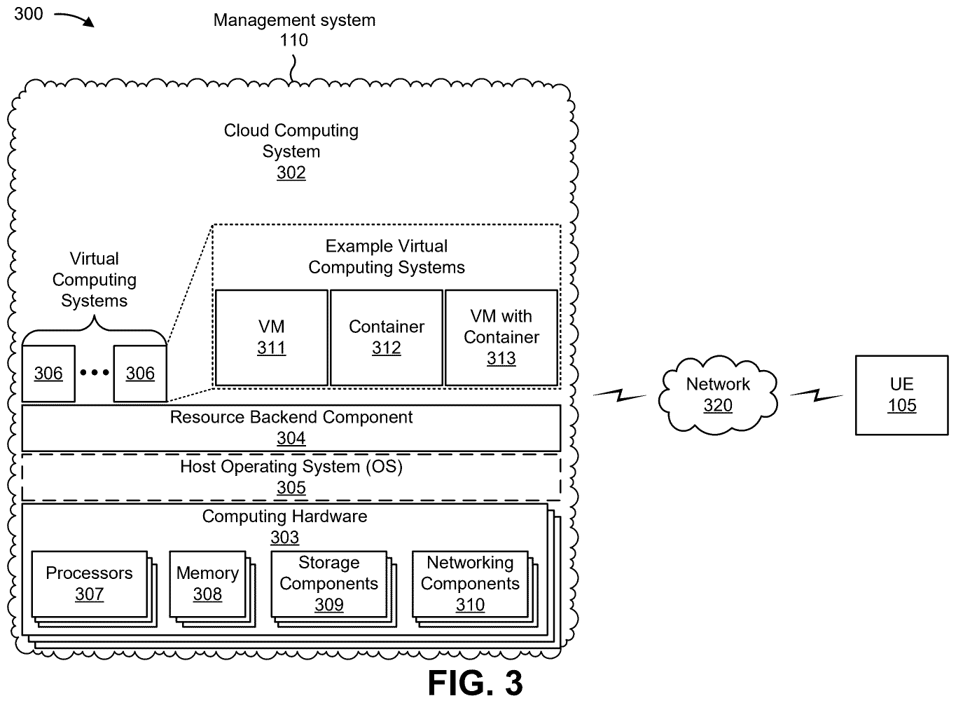

FIG. 3 is a diagram of an example environment 300 in which systems and/or methods described herein may be implemented. As shown in FIG. 3, the environment 300 may include the management system 110, which may include one or more elements of and/or may execute within a cloud computing system 302. The cloud computing system 302 may include one or more elements 303-313, as described in more detail below. As further shown in FIG. 3, the environment 300 may include the UE 105 and/or a network 320. Devices and/or elements of the environment 300 may interconnect via wired connections and/or wireless connections.

The UE 105 may include one or more devices capable of receiving, generating, storing, processing, and/or providing information, as described elsewhere herein. The UE 105 may include a communication device and/or a computing device. For example, the UE 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), an Internet of Things (IoT) device, a robot, an autonomous vehicle, or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311.

Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

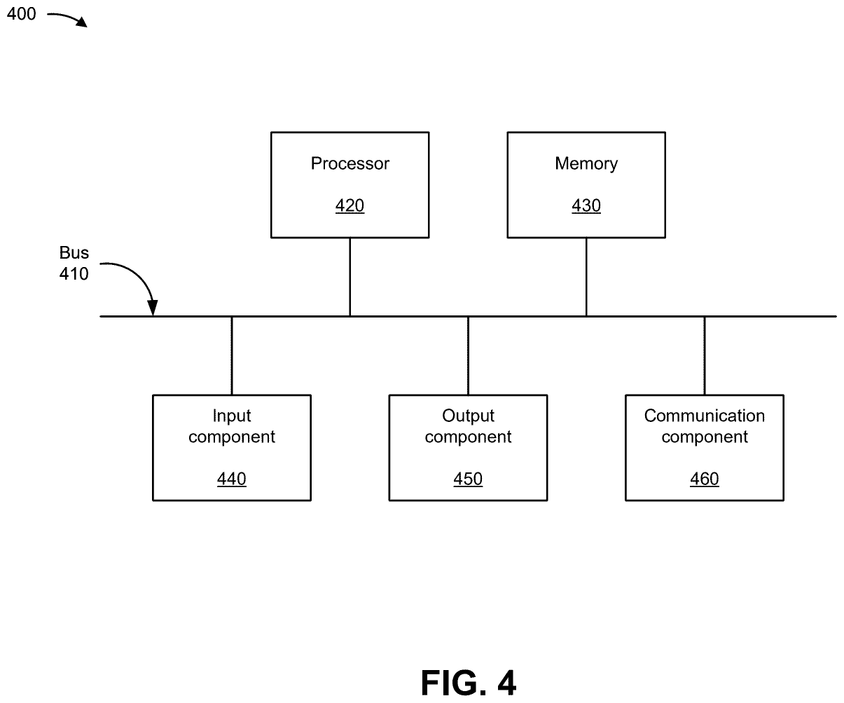

Although the management system 110 may include one or more elements 303-313 of the cloud computing system 302, may execute within the cloud computing system 302, and/or may be hosted within the cloud computing system 302, in some implementations, the management system 110 may not be cloud-based (e.g., may be implemented outside of a cloud computing system) or may be partially cloud-based. For example, the management system 110 may include one or more devices that are not part of the cloud computing system 302, such as the device 400 of FIG. 4, which may include a standalone server or another type of computing device. The management system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the UE 105 and/or the management system 110. In some implementations, the UE 105 and/or the management system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

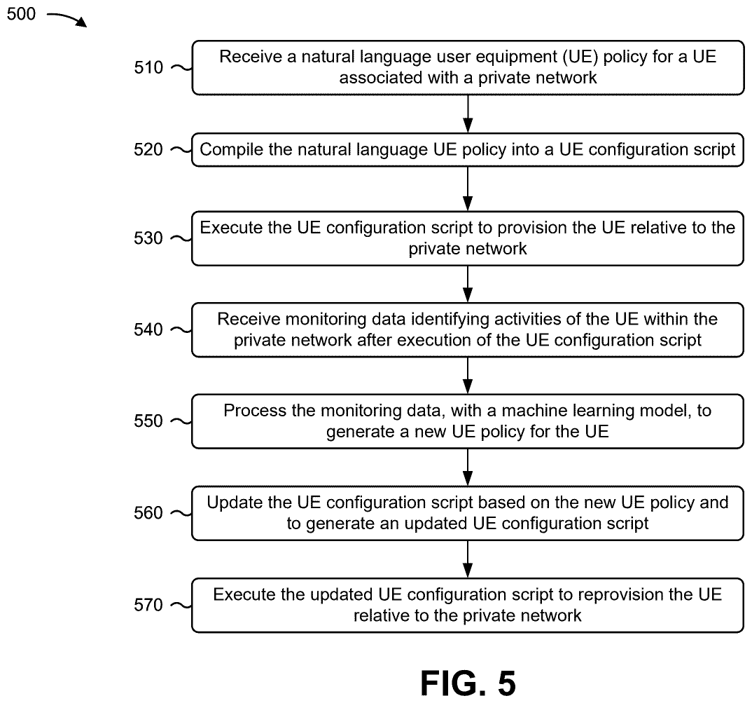

FIG. 5 is a flowchart of an example process 500 for providing adaptive UE management in a private network. In some implementations, one or more process blocks of Fig. 5 may be performed by a device (e.g., the management system 110). In some implementations, one or more process blocks of FIG. 5 may be performed by another device or a group of devices separate from or including the device, such as a UE (e.g., the UE 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a natural language UE policy for a UE associated with a private network (block 510). For example, the device may receive a natural language UE policy for a UE associated with a private network, as described above. In some implementations, the natural language UE policy includes one or more of a rule for geo-fencing, a rule for UE grouping, or a rule for security enforcement. In some implementations, receiving the natural language UE policy includes providing, to a private network administrator, a graphical user interface for describing UE policies and intents, and receiving the natural language UE policy via the graphical user interface.

As further shown in FIG. 5, process 500 may include compiling the natural language UE policy into a UE configuration script (block 520). For example, the device may compile the natural language UE policy into a UE configuration script, as described above. In some implementations, compiling the natural language UE policy into the UE configuration script includes processing the natural language UE policy, with a large language model, to generate the UE configuration script. In some implementations, compiling the natural language UE policy into the UE configuration script includes parsing the natural language UE policy using natural language processing techniques to determine an intent of the natural language UE policy, and generating the UE configuration script based on the intent of the natural language UE policy.

As further shown in FIG. 5, process 500 may include executing the UE configuration script to provision the UE relative to the private network (block 530). For example, the device may execute the UE configuration script to provision the UE relative to the private network, as described above. In some implementations, executing the UE configuration script to provision the UE relative to the private network includes one of executing the UE configuration script to activate the UE for the private network, or executing the UE configuration script to deactivate the UE with the private network.

As further shown in FIG. 5, process 500 may include receiving monitoring data identifying activities of the UE within the private network after execution of the UE configuration script (block 540). For example, the device may receive monitoring data identifying activities of the UE within the private network after execution of the UE configuration script, as described above. In some implementations, the monitoring data includes data identifying one or more of usage patterns associated with the UE, data consumption by the UE, or geographic locations associated with the UE.

As further shown in FIG. 5, process 500 may include processing the monitoring data, with a machine learning model, to generate a new UE policy for the UE (block 550). For example, the device may process the monitoring data, with a machine learning model, to generate a new UE policy for the UE, as described above.

As further shown in FIG. 5, process 500 may include updating the UE configuration script based on the new UE policy and to generate an updated UE configuration script (block 560). For example, the device may update the UE configuration script based on the new UE policy and to generate an updated UE configuration script, as described above.

As further shown in FIG. 5, process 500 may include executing the updated UE configuration script to reprovision the UE relative to the private network (block 570). For example, the device may execute the updated UE configuration script to reprovision the UE relative to the private network, as described above. In some implementations, executing the updated UE configuration script to reprovision the UE relative to the private network includes one of executing the updated UE configuration script to activate the UE for the private network, or executing the updated UE configuration script to deactivate the UE with the private network.

In some implementations, process 500 includes receiving a modification of the natural language UE policy, updating the updated UE configuration script based on the modification of the natural language UE policy and to generate a further updated UE configuration script, and executing the further updated UE configuration script to further reprovision the UE relative to the private network. In some implementations, process 500 includes receiving feedback associated with the natural language UE policy, and processing the feedback, with a large language model, to generate the modification of the natural language UE policy.

In some implementations, process 500 includes training the machine learning model using historical UE activity data received from the private network. In some implementations, process 500 includes utilizing predictive analytics on the monitoring data to recommend one or more new UE management actions for the UE configuration script. In some implementations, process 500 includes requesting approval of the new UE policy prior to updating the UE configuration script based on the new UE policy, and receiving approval of the new UE policy prior to updating the UE configuration script based on the new UE policy.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a user equipment (UE) policy for a UE associated with a private network;
compiling, by the device, a natural language UE policy into a UE configuration script;
executing, by the device, the UE configuration script to provision the UE relative to the private network;
receiving, by the device, monitoring data identifying activities of the UE within the private network after execution of the UE configuration script;
processing, by the device, the monitoring data, with a machine learning model, to generate a new UE policy for the UE;
updating, by the device, the UE configuration script based on the new UE policy and to generate an updated UE configuration script; and
executing, by the device, the updated UE configuration script to reprovision the UE relative to the private network.

2. The method of claim 1, wherein compiling the natural language UE policy into the UE configuration script comprises:
processing the natural language UE policy, with a large language model, to generate the UE configuration script.

3. The method of claim 1, further comprising:
receiving a modification of the natural language UE policy;
updating the updated UE configuration script based on the modification of the natural language UE policy and to generate a further updated UE configuration script; and
executing the further updated UE configuration script to further reprovision the UE relative to the private network.

4. The method of claim 3, further comprising:
receiving feedback associated with the natural language UE policy; and
processing the feedback, with a large language model, to generate the modification of the natural language UE policy.

5. The method of claim 1, wherein the natural language UE policy includes one or more of a rule for geo-fencing, a rule for UE grouping, or a rule for security enforcement.

6. The method of claim 1, further comprising:
training the machine learning model using historical UE activity data received from the private network.

7. The method of claim 1, wherein the monitoring data includes data identifying one or more of usage patterns associated with the UE, data consumption by the UE, or geographic locations associated with the UE.

8. A device, comprising:
one or more processors configured to:
receive a natural language user equipment (UE) policy for a UE associated with a private network;
compile the natural language UE policy into a UE configuration script;
execute the UE configuration script to provision the UE relative to the private network;
receive monitoring data identifying activities of the UE within the private network after execution of the UE configuration script,
wherein the monitoring data includes data identifying one or more of usage patterns associated with the UE, data consumption by the UE, or geographic locations associated with the UE;
process the monitoring data, with a machine learning model, to generate a new UE policy for the UE;
update the UE configuration script based on the new UE policy and to generate an updated UE configuration script; and
execute the updated UE configuration script to reprovision the UE relative to the private network.

9. The device of claim 8, wherein the one or more processors, to receive the natural language UE policy, are configured to:
provide, to a private network administrator, a graphical user interface for describing UE policies and intents; and
receive the natural language UE policy via the graphical user interface.

10. The device of claim 8, wherein the one or more processors are further configured to:
utilize predictive analytics on the monitoring data to recommend one or more new UE management actions for the UE configuration script.

11. The device of claim 8, wherein the one or more processors, to execute the UE configuration script to provision the UE relative to the private network, are configured to one of:
execute the UE configuration script to activate the UE for the private network; or
execute the UE configuration script to deactivate the UE with the private network.

12. The device of claim 8, wherein the one or more processors, to execute the updated UE configuration script to reprovision the UE relative to the private network, are configured to one of:
execute the updated UE configuration script to activate the UE for the private network; or
execute the updated UE configuration script to deactivate the UE with the private network.

13. The device of claim 8, wherein the one or more processors, to compile the natural language UE policy into the UE configuration script, are configured to:
parse the natural language UE policy using natural language processing techniques to determine an intent of the natural language UE policy; and
generate the UE configuration script based on the intent of the natural language UE policy.

14. The device of claim 8, wherein the one or more processors are further configured to:
request approval of the new UE policy prior to updating the UE configuration script based on the new UE policy; and
receive approval of the new UE policy prior to updating the UE configuration script based on the new UE policy.

15. A non-transitory computer-readable medium storing a set of instructions, the set of instructions comprising:
one or more instructions that, when executed by one or more processors of a device, cause the device to:
receive a natural language user equipment (UE) policy for a UE associated with a private network,
wherein the natural language UE policy includes one or more of a rule for geo-fencing, a rule for UE grouping, or a rule for security enforcement;
compile the natural language UE policy into a UE configuration script;
execute the UE configuration script to provision the UE relative to the private network;
receive monitoring data identifying activities of the UE within the private network after execution of the UE configuration script;
process the monitoring data, with a machine learning model, to generate a new UE policy for the UE;
update the UE configuration script based on the new UE policy and to generate an updated UE configuration script; and
execute the updated UE configuration script to reprovision the UE relative to the private network.

16. The non-transitory computer-readable medium of claim 15, wherein the one or more instructions, that cause the device to compile the natural language UE policy into the UE configuration script, cause the device to:
process the natural language UE policy, with a large language model, to generate the UE configuration script.

17. The non-transitory computer-readable medium of claim 15, wherein the one or more instructions further cause the device to:
train the machine learning model using historical UE activity data received from the private network.

18. The non-transitory computer-readable medium of claim 15, wherein the one or more instructions further cause the device to:
utilize predictive analytics on the monitoring data to recommend one or more new UE management actions for the UE configuration script.

19. The non-transitory computer-readable medium of claim 15, wherein the one or more instructions, that cause the device to execute the UE configuration script to provision the UE relative to the private network, cause the device to:
execute the UE configuration script to activate the UE for the private network; or
execute the UE configuration script to deactivate the UE with the private network.

20. The non-transitory computer-readable medium of claim 15, wherein the one or more instructions, that cause the device to compile the natural language UE policy into the UE configuration script, cause the device to:
parse the natural language UE policy using natural language processing techniques to determine an intent of the natural language UE policy; and
generate the UE configuration script based on the intent of the natural language UE policy.
